(19) United States
(12) Patent Application Publication
(10) Pub. No.: US 2002/0152397 A1
(43) Pub. Date: Oct. 17, 2002

(54) Virtual investigator

(76) Inventors: Drew McKay, Falls Church, VA (US); Stevens Miller, Ashburn, VA (US); Dave Sullivan, Oakton, VA (US); Pat Sullivan, Oakton, VA (US)

Correspondence Address: BAKER + HOSTETLER LLP, WASHINGTON SQUARE, SUITE 1100, 1050 CONNECTICUT AVE. N.W., WASHINGTON, DC, 20036-5304, US

(21) Appl. No.: 09/906,692

(22) Filed: Jul. 18, 2001

Related U.S. Application Data
(60) Provisional application No. 60/282,109, filed on Apr. 6, 2001.

(51) Int. Cl. G06F 12/14

(52) U.S. Cl. 713/200

(57) ABSTRACT

Methods and apparatus for determining the activities conducted on a computer system, which are particularly suited for monitoring personal computer usage are disclosed. An application of this method and apparatus to personal computers is also disclosed.

### PRIORITY

This application claims priority to the provisional patent application entitled, “Virtual Investigator,” filed Apr. 6, 2001, the disclosure of which is incorporated herein by reference.

### FIELD OF THE INVENTION

The present invention relates generally to monitoring non-volatile data on a computer system. More particularly, the present invention relates to methods and apparatus for monitoring activities conducted on a personal computer.

### BACKGROUND OF THE INVENTION

Increasingly the personal computer is being utilized for all facets of professional and personal activities. As a by-product of this computer usage, various data are created, modified and accessed. The portions of these data which are recorded on the computer's non-removable and non-volatile media are retained even when the computer is not operating. These non-volatile data reflect the characteristics of the computer activities through which they were created, modified or accessed and continue to reflect such characteristics until they are accessed or modified as a by-product of subsequent activity or until they are explicitly accessed or modified by direct reference.

In the corporate environment much of a company's confidential and trade secret information is maintained on the computer network and can be freely accessed by many if not all employees. Instances may arise where it would be beneficial to monitor the information accessed by an employee over some period of time, e.g., when it is suspected that the employee is planning to leave. It would be also beneficial if the method of monitoring such usage did not leave a “foot print” on the employee's computer that the monitoring occurred and to preserve the integrity of the data stored in memory so that it could later be used, e.g., for evidentiary purposes.

The present invention provides a new and useful way to utilize these non-volatile data to determine the nature of activities conducted on a personal computer. The present invention specifically utilizes these data to determine whether activities conducted on a personal computer may be related to unfavorable conduct by the computer user who performed those activities.

The present invention is unlike other methods or processes presently used to discover unfavorable conduct in the following ways: the present invention does not require installation of any hardware or software component before the activities to be evaluated take place (i.e., the present invention may run after questionable conduct is suspected); the present invention operates without changing the data it analyzes, thereby preserving such data for subsequent more detailed analysis; the present invention's operation cannot be detected after it has been completed and therefore can be run repeatedly on successive days to determine a pattern of activities; and the present invention can perform an analysis on any personal computer regardless of the software applications or packages employed by its user.

The above features can be instrumental in the gathering of information. For example, law enforcement agencies could use the present invention to check copyright violations by identifying what programs are loaded on a computer and when they were loaded.

### SUMMARY OF THE INVENTION

The foregoing needs have been satisfied to a great extent by the present invention wherein, in one aspect of the invention a method of determining the activities conducted on a computer system is disclosed. First a source medium is inserted into a non-volatile storage device interface of a computer system, wherein the source medium includes a collector process program. Next, the computer system is booted up from a collector process program which in turn is loaded into the volatile memory of the computer system. The collector program accesses and examines each non-volatile memory storage device of the computer system while constructing a record of the contents of each non-volatile memory storage device. Then, the program compresses the record of contents onto the source medium while formatting and overwriting the program with the record of contents. Subsequently, all records of the program are erased from the volatile memory of the computer system. Later, the record of contents is decompressed and read from the source medium for analysis and tabulation for output to a user.

In another aspect of the invention, a magnetic storage device containing a program for recording data representative of non-volatile memory on a computer is described. The program contains at least the following: one code segment which boots up the computer; one code segment which loads the program only into volatile memory of the computer; one code segment which examines each non-volatile memory storage device of the computer; one code segment which constructs a record of the contents of each non-volatile memory storage device; one code segment which compresses the record of contents onto the magnetic storage device; and one code segment which formats and overwrites the program with the record of contents for further analysis.

There has thus been outlined, rather broadly, the more important features of the invention in order that the detailed description thereof that follows may be better understood, and in order that the present contribution to the art may be better appreciated. There are, of course, additional features of the invention that will be described below and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein, as well as the abstract, are for the purpose of description and should not be regarded as limiting.

As such, those skilled in the art will appreciate that the conception upon which this disclosure is based may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

### BRIEF DESCRIPTION OF THE DRAWINGS

FIG. 1 is a flow chart of a preferred embodiment of the Collector process of the present invention.

FIG. 2 is a flow chart of a preferred embodiment of the Reporter process of the present invention.

FIGS. 3a & 3b are flow charts of the preferred embodiment of FIG. 2 showing further details.

### DETAILED DESCRIPTION OF A PREFERRED EMBODIMENT OF THE INVENTION

The present invention is comprised of two related processes which are performed separately. The first is the Collector process 10 which is performed on the computer suspected of having been the host of activities which are to be investigated (the target computer, not shown). The second is the Reporter process 30 which may be performed on any computer and operates upon the data collected and recorded by the Collector process 10.

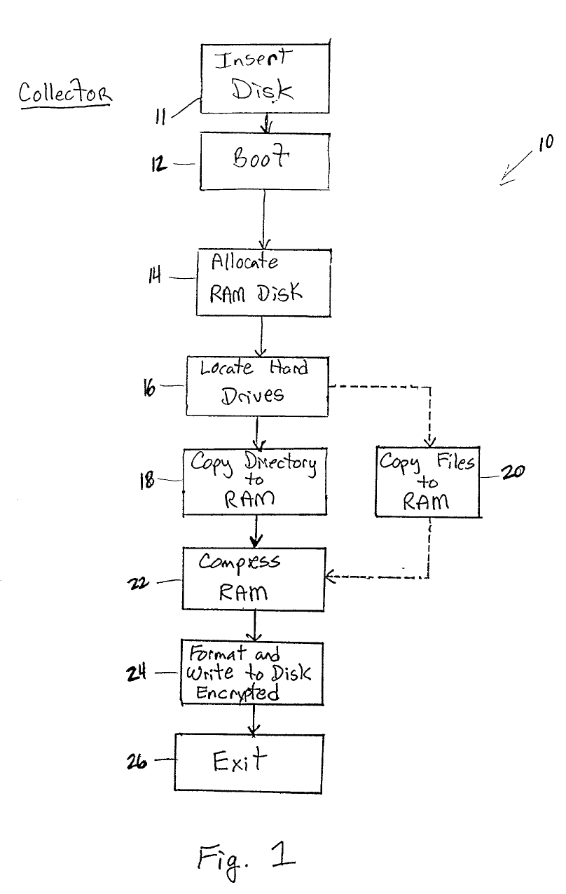

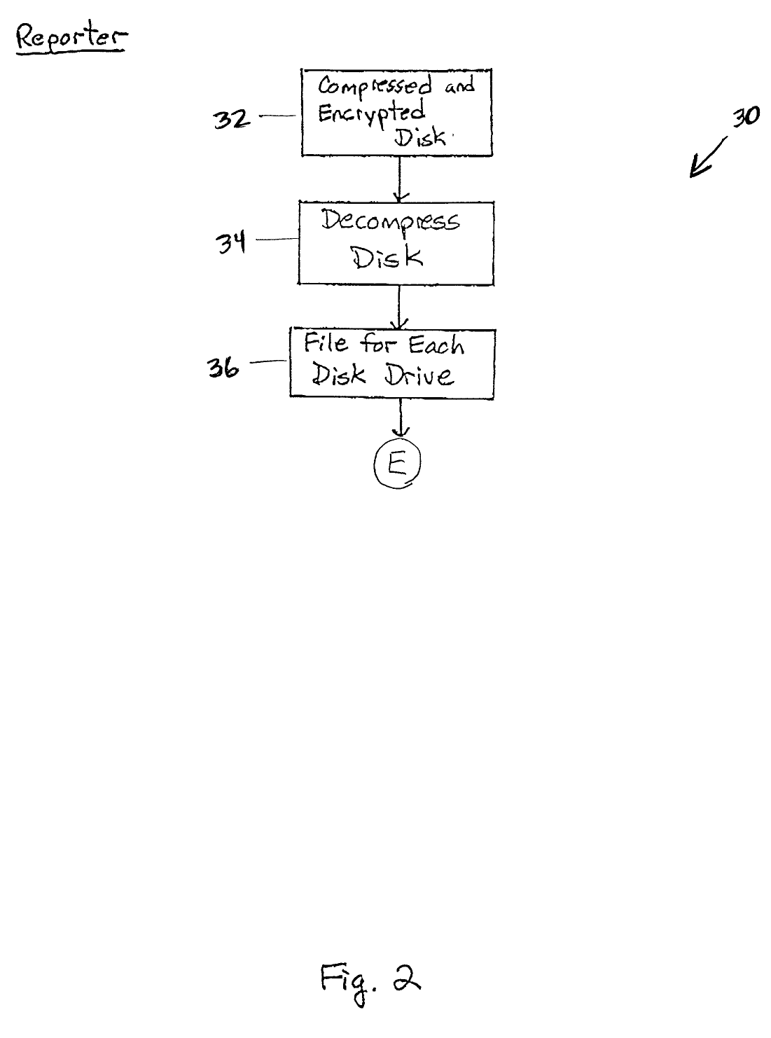

Referring to FIG. 1, the Collector process 10 is implemented through a computer program written in any language. In the preferred embodiment, the Collector process 10 is written in the “C” programming language. The Collector process 10 will operate on any target computer which has non-volatile memory storage devices 16 attached to it internally or externally. In the preferred embodiment the Collector process 10 operates upon target computers which operate under the Microsoft Windows™ operating systems and utilize non-volatile memory devices 16 that include an input/output interface (not shown) that is compatible with the BIOS standard for the Microsoft Disk Operating System™ (DOS).

The Collector process 10 may be conveyed to the target computer on any media from which the target computer is capable of performing the “BOOT” process 12, and the results of the Collector process 10 may be recorded on any removable medium upon which the target computer is capable of recording. In the preferred embodiment, the source medium 11 also serves as the storage medium 24 for the results of the Collector process 10.

In the preferred embodiment, the Collector process 10 is “manufactured” onto an industry-standard 3½ inch diskette 11 which may be stored for an indefinite amount of time until it is needed. In the preferred embodiment, operation of the Collector process 10 is initiated by placing the diskette 11 into the diskette drive of the target computer while it is in a power-off condition and then turning power on. This will cause the Collector process 10 to be loaded into the volatile memory 14 (e.g., RAM) of the target computer but will not affect the non-volatile memory 16 (e.g., Hard Drive). The Collector process 10 then examines each of the non-volatile storage devices 16 connected to the target computer and constructs a record of their contents in the volatile memory 14 of the target computer.

The records of contents are generated by the Collector process 10 first looking to the directory 18 on the target computer to construct a database. The database is then compressed, encrypted, and stored 24 as described below.

This record of contents is performed upon all aspects of the data recorded upon the non-volatile memory 16 as a by-product of these activities. These include but are not limited to: the date and time a “file” was first recorded in the non-volatile memory; the date and time the “file” was last modified; the date and time this “file” was last accessed by a computer program; the “file” name; the “file” type; the “file” size; the “file” archive, read-only, and other attributes; the “file” content; the related “files” for this “file”; and the logical location of this “file” within the non-volatile memory structure (i.e., FAT 16 or FAT 32). In addition to identifying standard “files” and “folders,” the Collector process 10 can be configured to capture information about hidden files, system files, and in certain cases, erased files. “Files” 20 may also be looked for and identified according to sectors of interest using targeted “file” names or “file” extensions, and the full content of these “files” can be collected for analysis.

The data collected from the non-volatile disk devices 16 are reduced in size by an arbitrary data compression technique 22 (e.g., 300 files reduced to size of 20 files). This compression process may include or be followed by an arbitrary encryption process. These compressed, and optionally encrypted 24, data are then written to the original diskette replacing the Collector process 10 program files with the results of the Collector process 10. Using the preferred embodiment, about 40,000 directory entries can be stored on a standard high-density diskette. This is more than the number usually found on the average personal computer. Power on the target computer is then turned off 26 causing all records of the Collector process 10 to be erased from volatile memory of the computer thereby not leaving any “footprint” for the computer user to see or find.

The diskette 24 produced by this Collector process 10 serves as the input for the subsequent Reporter process 30.

The Reporter process 30 is contained on a standard computer and can be configured to run on any industry-standard or custom operating software. In the preferred embodiment, the Reporter process 30 operates under the Microsoft Windows™ operating system (e.g., Windows 95™, Windows 98™). The Reporter process 30 is implemented through a computer program written in any language. In the preferred embodiment the Reporter process 30 is written in Microsoft Visual Basic™ programming language.

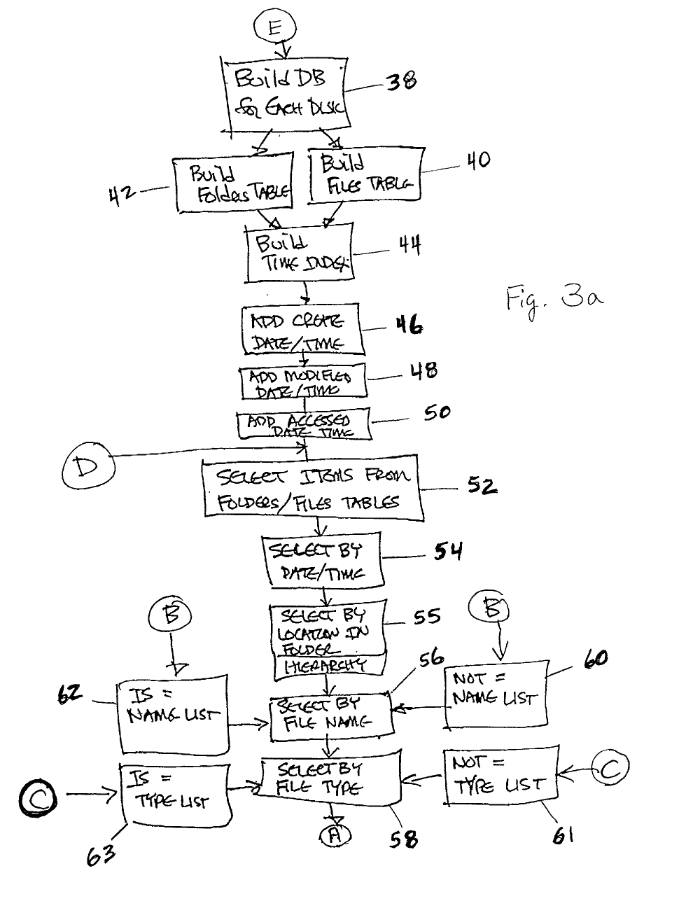

Referring to FIG. 2, the Reporter process 30 reads the data recorded by the Collector process 10 from the medium 32 on which it was recorded. In the preferred embodiment, these data are read from 3½ inch diskettes. These data are then decompressed 34 using a complement of the data compression technique applied by the Collector process 10, and optionally unencrypted using a complement of the Collector process 10 encryption 24, thereby restoring the data collected about the content of the target computer's non-volatile memory devices 16 to their original form 36. In the preferred embodiment the data is then organized into relational database tables 38, indexed by all available date/time fields 44 and cross-linked to recreate the original target computer directory structure 40, 42.

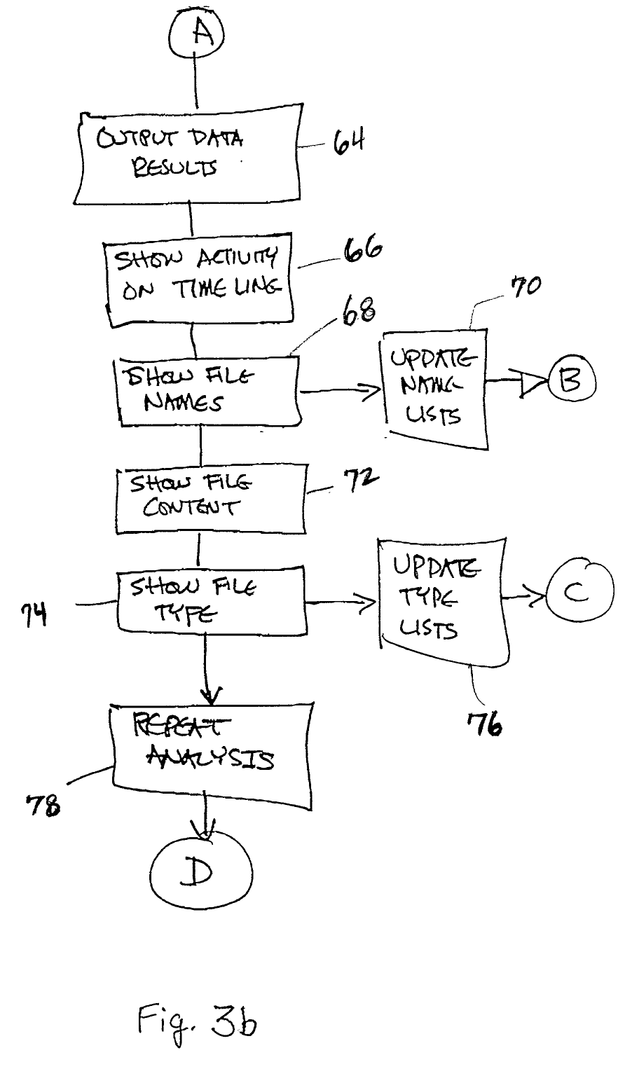

Referring to FIGS. 3a and 3b, the Reporter process 30 performs a multi-step analysis process of these data in order to identify the characteristics of activities conducted on the target computer. This analysis is performed upon all aspects of the data recorded upon the non-volatile memory 16 as a by-product of these activities. These include but are not limited to: the date and time a “file” was first recorded in the non-volatile memory 46; the date and time the “file” was last modified 48; the date and time this “file” was last accessed 50 by a computer program; the “file” name; the “file” type; the “file size; the “file” archive, read-only, and other attributes; the “file” content; the related “files” for this “file”; and the logical location of this “file” within the non-volatile memory structure (i.e., FAT 16 or FAT 32).

The Reporter process 30 renders the results 64 of its analysis in a form most suitable for determining whether activities conducted on the target computer may be related to unfavorable conduct by the computer user who performed those activities. This rendering includes but is not limited to: the presentation of “files” whose dates of creation, modification, or access are within a specific range of dates 52, 54; the presentation of “files” whose names conform to certain patterns 56; the presentation of “files” whose types are any of a selected set of types 58, 63; the presentation of “files” whose type are not of a selected set of types 58, 61; the presentation of “files” whose locations within the logical structure of the non-volatile memory are in a selected set of locations 56, 62; the presentation of “files” whose locations within the logical structure of the non-volatile memory are not in a selected set of locations 56, 60; any logical combination of the above renderings with any combination of the Boolean AND and OR operators; a distinct set of renderings each of which may include any logical combination of the above renderings with any combination of the Boolean AND and OR operators; and a graphic representation of one or more characteristics of the “files” included in any of the above renderings 66, 68, 72 and 74.

The Reporter process 30 may be varied so that the one set of renderings is based upon one or more other sets of renderings produced by the Reporter process 30. The sets of renderings used as input to the Reporter process 30 may be generated by an analysis of any of the data collected about the content of any target computer's non-volatile storage devices 16 (e.g., Hard Drive). Thus, the Reporter process 30 may be varied without limit by utilizing the results of its processing to vary subsequent processing 70, 76 and 78.

It is envisioned that the present invention may also examine data recorded by Internet browser programs in non-volatile storage to produce Internet usage profiles for the target computer's users.

### Appendix

Attached are operating instructions which is supporting information that may be useful in describing the invention.

The above description and drawings are only illustrative of preferred embodiments which achieve the objects, features, and advantages of the present invention, and it is not intended that the present invention be limited thereto. Any modifications of the present invention which comes within the spirit and scope of the following claims is considered to be part of the present invention.

[image]

What is claimed is:

1. A method of determining the activities conducted on a computer system, comprising the steps of:
inserting a source medium into a non-volatile storage device interface of said computer system, wherein said source medium includes a collector process program;
booting up said computer system from said collector process program;
loading said collector process program only into volatile memory of said computer system;
accessing said collector process program to examine each non-volatile memory storage device of said computer system;
constructing a record of the contents of each said non-volatile memory storage device by using said collector process program;
compressing said record of contents;
formatting and overwriting said collector process program with said record of contents; and
erasing all records of said collector process program from said volatile memory of said computer system.

2. The method of claim 1, wherein the step of constructing a record of content further includes copying the directory of each said non-volatile memory storage device.

3. The method of claim 1, wherein the step of constructing a record of content further includes copying files of each said non-volatile memory storage device.

4. The method of claim 1, wherein said non-volatile memory storage device is a hard drive.

5. The method of claim 1, wherein said source medium is a high density 3½ inch diskette.

6. The method of claim 1, wherein said source medium is a CD-RW disk.

7. The method of claim 1, further comprising the step of encrypting said compressed record of content prior to formatting and overwriting said collector process program with said encrypted compressed record of contents.

8. The method of claim 1, further comprising the steps of decompressing and reading said record of contents from said source medium; and analyzing and tabulating said record of contents for output to a user

9. The method of claim 8, further comprising the step of encrypting said compressed record of contents prior to formatting and overwriting said collector process program with said encrypted compressed record of contents.

10. The method of claim 9, further comprising the step of decrypting said source medium.

11. The method of claim 8, wherein said analyzing and tabulating step further comprises the steps of:
building a tabulated database for each said non-volatile memory storage device comprising time and date, access, file type, and modification indexes;
selecting items from said tabulated database, wherein at least one of said items includes any one of time and date, access, file type, and modification data; and
outputting data results for the user to view.

12. The method of claim 11, wherein said data results includes at least one of file names, file types, file contents, and a timeline of activity.

13. The method of claim 11, wherein said data results includes at least one of file types and file names.

14. The method of claim 12, further comprising the step of updating said file type data with said data results.

15. The method of claim 12, further comprising the step of updating said file name data with said data results.

16. The method of claim 11, wherein said computer system is a personal computer.

17. A magnetic storage device containing a program for recording data representative of non-volatile memory on a computer, said program comprising:
one code segment which boots up said computer;
one code segment which loads said boot up program only into volatile memory of said computer;
one code segment which examines each non-volatile memory storage devices of said computer following boot up;
one code segment which constructs a record of the contents of each said non-volatile memory storage device based on the examination of the non-volatile memory storage devices;
one code segment which compresses said record of contents onto said magnetic storage device; and
one code segment which formats and overwrites said magnetic storage device with said record of contents.

18. A magnetic storage device containing a program for recording data representative of non-volatile memory on a computer, said program comprising:
means for booting up said computer from said program;
means for loading said program only into volatile memory of said computer;
means for accessing said program to examine each non-volatile memory storage device of said computer;
means for constructing a record of the contents of each said non-volatile memory storage device by using said program;
means for compressing said record of contents onto said magnetic storage device;
means for formatting and overwriting said program with said record of contents;
means for erasing all records of said program from said volatile memory of said computer;
means for decompressing and reading said record of contents from said magnetic storage device; and
means for analyzing and tabulating said record of contents for output to a user.

19. The magnetic storage device of claim 18, further comprising means for encrypting said magnetic storage device.

20. The magnetic storage device of claim 19, further comprising:
means for building a tabulated database for each said non-volatile memory storage device including time and date, access, file type, and modification indexes;
means for selecting items from said tabulated database, wherein at least one of said items includes any one of time and date, access, file type, and modification data; and
means for outputting data results for the user to view.
